(19) United States
(12) Patent Application Publication
(10) Pub. No.: US 2008/0007792 A1
(43) Pub. Date: Jan. 10, 2008

(54) MODULAR DOCUMENT CAMERA

(75) Inventors: Shi-Mu Sun, Taipei (TW); Ying-Min Hwang, Taipei (TW); Chih-Ming Chen, Taipei (TW); Christopher Yen, Taipei (TW)

Correspondence Address: KIRTON AND MCCONKIE, 60 EAST SOUTH TEMPLE,, SUITE 1800, SALT LAKE CITY, UT, 84111, US

(73) Assignee: AVERMEDIA TECHNOLOGIES, INC., Taipei Hsien (TW)

(21) Appl. No.: 11/670,197

(22) Filed: Feb. 1, 2007

(30) Foreign Application Priority Data
Jul. 10, 2006 (TW) 095125127

(51) Int. Cl. H04N 1/00

(52) U.S. Cl. 358/403

(57) ABSTRACT

A document camera is used for capturing and outputting images of an object to be displayed. The document camera is detachably coupled with a presentation station module and includes a main body, a camera module, a first operating panel and an expansion interface. The camera module is disposed on the main body for capturing the images of the object. The first operating panel is disposed on the main body and operated by a user to control an image-capturing operation of the camera module and an image outputting operation. The expansion interface is disposed on the main body. The functions of the document camera are expanded when the camera module is coupled with the presentation station module via the expansion interface.

### FIELD OF THE INVENTION

The present invention relates to a modular document camera, and more particularly to a modular document camera having expanded functions by coupling a document camera with a presentation station module.

### BACKGROUND OF THE INVENTION

A document camera or a digital visual presenter is a special camera designed to make a presentation, hold a meeting or give a lecture in classroom, boardroom, or conference. By using the document camera, the lecturer may directly display images of a writing or graphic object to assisting understanding.

Generally, the document cameras or the digital visual presenters have many useful features as video cameras or scanners have, for example image capturing, image scanning and image outputting functions. Like digital video cameras, digital still cameras, surveillance cameras or PC cameras, the camera modules used in the document cameras for sensing images are usually CMOS (complementary metal-oxide semiconductor) image sensing modules or CCD (charged coupled device) image sensing modules. The document camera or the digital visual presenter may be communicated with a projector. The captured images to be shown to the audience will be projected onto a screen through the projector. Moreover, the camera module contained in the document camera or the digital visual presenter may transmit the captured images to a television or a computer monitor so as to display live video images. In addition, the objects to be shown through the document camera or the digital visual presenter may be planar or three dimensional objects.

Conventionally, it is inconvenient for giving a presentation because the speech manuscripts, reference documents or drawings should have been previously scanned by an image scanner, transformed into image files and then displayed on a computer monitor or a projector screen. In addition, the documents or drawings may have been previously printed on the transparent slides by colorful or black-and-white printing. The use of the document camera or the digital visual presenter may significantly reduce the burden of preparing presentation and easily allow the lecturer to share details with the audience.

Referring to FIG. 1, a schematic diagram of a conventional portable document camera 10 used for projecting images of an object 1 in a presentation is illustrated. The portable document camera 10 has a camera module 11 such as a CCD or CMOS image sensing module. First of all, the document to be presented is placed under the camera module 11. The images of the object 1 are captured by the camera module 11 and transmitted to a projector 12. Then, the captured images are projected onto a screen 14 through the projector 12, so that the images of the object 1 will be displayed on the screen 14.

Referring to FIG. 2, a schematic diagram of a conventional flatbed document camera 20 used for projecting images of an object 2 in a presentation is illustrated. The operation principles of the flatbed document camera 20 are similar to those described in FIG. 1 and are not redundantly described herein. In addition, the flatbed document camera 20 has a platform 201 for placing the object 2 thereon. Optionally, a light box (not shown) is disposed within the platform 201 for emitting a light on the object 2. In addition, the flatbed document camera 20 has a lighting module 211 for providing light compensation such that the images of the object 2 will be clearly captured by the camera module 21. Likewise, the images of the object 1 captured by the camera module 11 are transmitted to a projector 22 and projected onto a screen 24, so that the images of the object 2 will be displayed on the screen 24.

The portable document camera 10 and the flatbed document camera 20 are two major types of document cameras in the industries. The functions, the applications and the costs of these two document cameras are somewhat distinguished. Generally, the portable document camera 10 is available to be carried to other locations because it is relatively lighter and handier. Due to the portability, the portable document camera 10 lacks of the platform or other platforms with expanded functionality. In comparison with the flatbed document camera 20, the portable document camera 10 has limited functions. For example, since no light compensation function is offered by the portable document camera 10, the image quality is deteriorated. In addition, since the portable document camera 10 is light and handy, it is readily suffered from vibration during operation.

In contrast, the above drawbacks are eliminated by using the flatbed document camera 20 of FIG. 2. Since flatbed document camera 20 has the platform, the overall volume or weight thereof is relatively larger and it is troublesome to carry this flatbed document camera 20. Moreover, since the portable document camera 10 is more cost-effective than the flatbed document camera 20, the portable document camera 10 prevails at this moment.

Therefore, it is an important issue for a manufacturer to provide an improved document camera capable of achieving the advantages of these two types of document cameras. Moreover, in a case that the portable document camera 10 is upgraded to have the advantages of the flatbed document camera 20, the additional cost should be minimized without impairing the functions thereof.

### SUMMARY OF THE INVENTION

The present invention provide a document camera detachably coupled with a presentation station module, in which the document camera is selectively served as a portable document camera when detached from the presentation station module or served as a flatbed document camera when coupled with the presentation station module.

In accordance with a first aspect of the present invention, there is provided a document camera for capturing and outputting images of an object to be displayed. The document camera is detachably coupled with a presentation station module and comprises a main body, a camera module, a first operating panel and an expansion interface. The camera module is disposed on the main body for capturing the images of the object. The first operating panel is disposed on the main body and operated by a user to control an image-capturing operation of the camera module and an image outputting operation. The expansion interface is disposed on the main body. The functions of the document camera are expanded when the document camera is coupled with the presentation station module via the expansion interface.

In an embodiment, the main body further includes a camera stand detachably coupled with the camera module, wherein the camera module is electrically connected to the camera stand when the camera module is coupled with the camera stand.

In an embodiment, the first operating panel includes a plurality of function keys.

In an embodiment, the presentation station module includes a second operating panel, which includes a plurality of function keys.

In an embodiment, the camera module is electrically connected to the presentation station module when the camera module is coupled with the presentation station module, so that the second operating panel is operated by the user to control the image-capturing operation of the camera module and the image outputting operation.

In an embodiment, the presentation station module is a multi-functional presentation station module for expanding the functions of the document camera.

In an embodiment, the functions of the document camera expanded by the presentation station module include provision of light compensation by a light box of the presentation station module.

In accordance with a second aspect of the present invention, there is provided a document camera system for capturing and outputting images of an object to be displayed. The document camera system includes a document camera and a presentation station module. The document camera includes a camera module for capturing the images of the object. The presentation station module is selectively coupled with or detached from the document camera. The functions of the document camera are expanded when the document camera is coupled with and electrically connected to the presentation station module. A first operating panel of the document camera is operated by a user to control an image-capturing operation of the document camera and an image outputting operation when the document camera is detached from the presentation station module.

In an embodiment, the document camera further includes a camera stand detachably coupled with the camera module, wherein the camera module is electrically connected to the camera stand when the camera module is coupled with the camera stand.

In an embodiment, a second operating panel of the presentation station module is operated by the user to control the image-capturing operation of the camera module and the image outputting operation when the document camera is coupled with and electrically connected to the presentation station module.

In an embodiment, the presentation station module further includes a platform for placing the object thereon.

In an embodiment, the presentation station module further includes a light box for providing light compensation when the images of the object are captured by the camera module.

In accordance with a third aspect of the present invention, there is provided a document camera for capturing and outputting images of an object to be displayed. The document camera is detachably coupled with a presentation station module and comprises a base, a camera stand, a camera module, a first operating panel and an expansion interface. The camera stand is disposed on the base. The camera module is disposed on the camera stand for capturing the images of the object. The first operating panel is arranged on the base and operated by a user to control an image-capturing operation of the camera module and an image outputting operation. The expansion interface is disposed on the main body. The functions of the document camera are expanded when the base of the document camera is coupled with the presentation station module via the expansion interface.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram of a conventional portable document camera;

FIG. 2 is a schematic diagram of a conventional flatbed document camera;

FIG. 3(a) is a schematic exploded view of a document camera system according to a first preferred embodiment of the present invention;

FIG. 3(b) is a schematic assembled view of the document camera system of FIG. 3(a);

FIG. 3(c) is a schematic view showing the assembled manner of a camera module and a camera stand;

FIGS. 4(a) and 4(b) are schematic side views of the document camera and the presentation station module before and after the assembly, respectively;

FIG. 5 is a schematic view of a document camera system according to a second preferred embodiment of the present invention;

FIG. 6 is a schematic view of a document camera system according to a third preferred embodiment of the present invention; and

FIG. 7 is a schematic view of a document camera system according to a fourth preferred embodiment of the present invention.

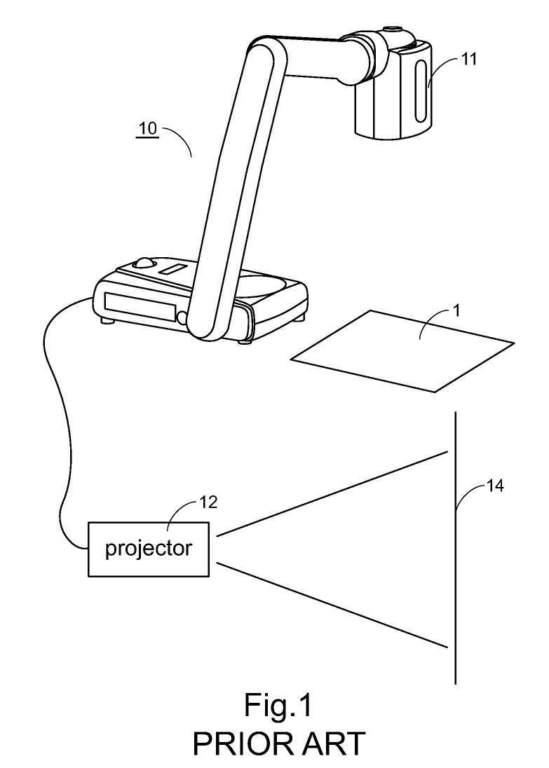

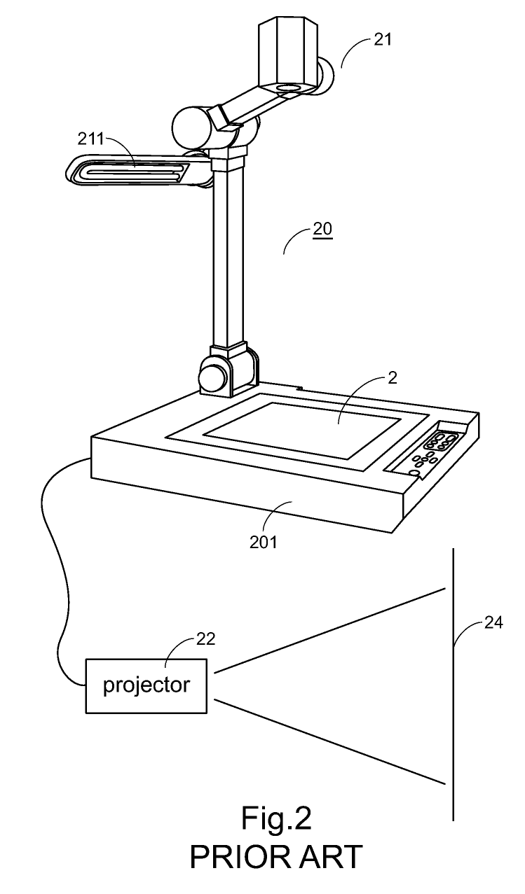

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

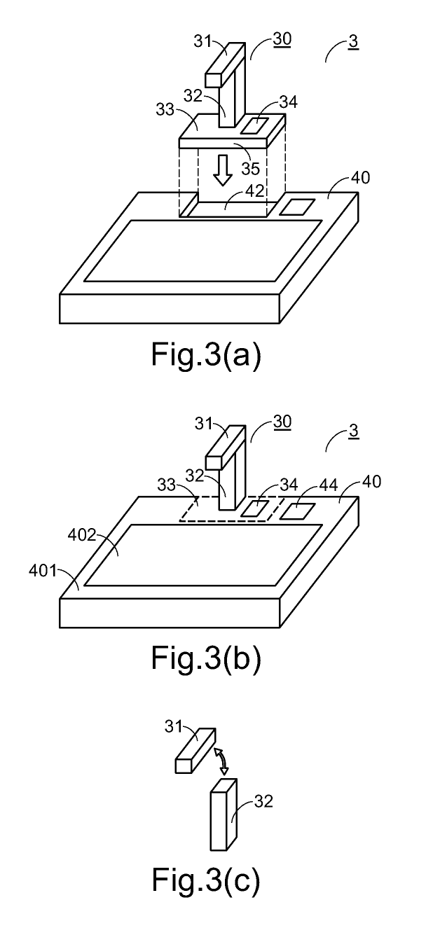

Referring to FIG. 3(a), a schematic exploded view of a document camera system according to a first preferred embodiment of the present invention is illustrated. The document camera system 3 includes a document camera 30 and a presentation station module 40. The document camera 30 has a main body including a camera stand 32 and a base 33. The camera stand 32 is disposed on the base 33. A camera module 31 is supported on the camera stand 32 for capturing the images of an object (not shown). The captured images are then processed by related hardware or processor included in the main body of the document camera 30 and transmitted to a projector via an image output interface (not shown). The processed images are projected onto a screen, so that the images of the object will be displayed on the screen. The operation principles of projector and the screen are known in the art and are not redundantly described herein.

Please refer to FIG. 3(a) again. An operating panel 34 is mounted on the base 33 or other locations. The operating panel 34 includes several function keys, which are activated to execute corresponding image-capturing and outputting functions such as shooting range settings, focus settings and so on. By activating the function keys of the operating panel 34, the camera module 31 is controlled to execute corresponding image-capturing functions or outputting the captured images. Like the portable document camera as is described above, the document camera 30 of this embodiment is light, handy and portable. In addition, since the document camera 30 only has the basic functions of capturing and outputting images, the document camera 30 is as cost-effective as the portable document camera.

Particularly, a presentation station module 40 is provided for executing expanded functions. Furthermore, the presentation station module 40 is selectively coupled with or detached from the document camera 30 as required. As shown in FIG. 3(a), the presentation station module 40 further includes a connecting interface 42 corresponding to an expansion interface 35 of the base 33 of the document camera 30. The connecting interface 42 and the expansion interface 35 have complementary shapes and corresponding engaging elements so that they can engage with each other perfectly to expand the functions of the document camera 30. That is, if the document camera 30 is coupled to the presentation station module 40, the document camera system 3 has full functions as the conventional flatbed document camera has. Whereas, if the document camera 30 is detached from the presentation station module 40, the document camera 30 is similar to the portable document camera.

After the document camera 30 is assembled with the presentation station module 40, a schematic assembled view of the document camera system can be seen in FIG. 3(b). The presentation station module 40 of the present invention contains additional components for executing extended functions. For example, the presentation station module 40 includes a platform 401 for placing an object thereon. The presentation station module 40 is effective to enhance stability of the document camera 30. Optionally, a light box 402 is provided for providing light compensation such that the images of the object will be clearly captured by the camera module 31. It is of course that the presentation station module 40 further includes a power supply terminal (not shown) for transmitting electricity to the light box 402. Moreover, the presentation station module 40 includes another operating panel 44. The operating panel 44 includes several function keys, which are activated to execute functions associated with the presentation station module 40.

From the above description, it is found that the document camera system 3 has full functions as the flatbed document camera can provide when the document camera 30 is assembled with the presentation station module 40. For example is, the document camera system 3 has advantages of excellent stability and light compensation as the flatbed document camera. As a consequence, the document camera system 3 has good flexibility and selectivity in operation.

For a purpose of achieving good image quality and stability, the document camera 30 may be assembled with the presentation station module 40. Whereas, when portability and handiness are required, the document camera 30 may be detached from the presentation station module 40 and only the document camera 30 is carried. Since the document camera system 3 can be operated as either a portable document camera or a flatbed document camera, the application of the document camera system 3 is expandable.

As previously described, the portable document camera is more cost-effective than the flatbed document camera. In accordance with the present invention, the user may purchase the document camera 30 in advance due to the cost consideration. In a case that better stability or better image quality is desired or the cost is acceptable, the presentation station module 40 may be additionally purchased so that the portable document camera 30 can be upgraded to a flatbed document camera. After the document camera 30 is assembled with the presentation station module 40, the operations of the document camera system 3 are substantially identical to those of the flatbed document camera.

Please refer to FIG. 3(c). The camera module 31 is detachably mounted on the camera stand 32. In a case that the camera module 31 has a breakdown, the camera module 31 may be detached from the camera stand 32 for repair or replaced with a new one. After the camera module 31 is assembled with the camera stand 32, the camera module 31 is electrically connected to the hardware or processor included in the main body of the document camera 30.

As known, the camera module of the conventional portable or flatbed document camera is fixed on the camera stand and is not replaceable. For obtaining higher-quality images, a flatbed document camera having a higher-resolution camera module is needed. However, the user is not allowed to replace the lower-resolution camera module with a higher-resolution camera module. The user has to purchase a new document camera equipped with a higher-resolution camera module to obtain the required image quality.

In accordance with the present invention, the camera module 31 is designed as a replaceable module. As a consequence, several camera modules with different levels or costs will be produced according to the manufacturer's design and/or the market's requirement. It is of course that the replaced camera module is compatible with the hardware or processor originally included in the main body of the document camera 30. Due to the cost consideration, the user may purchase a lower-resolution camera module in advance. In a case that better image quality is desired or the cost becomes acceptable, a higher-resolution camera module may be purchased to replace the lower-resolution camera module. Under this circumstance, the remaining components can be retained so as to reduce additional cost.

Optionally, the connecting interface 42 and the expansion interface 35 may include associated signal input/output ports (not shown). After the connecting interface 42 is coupled with the expansion interface 35, the document camera 30 is electrically connected to the presentation station module 40 via these signal input/output ports. Meanwhile, during operation of the document camera system 3, the user may operate the operating panel 44 of the presentation station module 40 to execute the image-capturing and outputting functions. Since the functions of the presentation station module 40 and the document camera 30 are integrated, the functions of the document camera 30 are expanded. Under this circumstance, the function keys of the operating panel 44 of the presentation station module 40 may include the function keys of the operating panel 34 of the document camera 30 and other additional function keys for executing additional functions. As a consequence, the entire functions of the document camera system 3 can be executed by operating only the operating panel 44 of the presentation station module 40.

In some embodiments, the function keys of the operating panel 34 of the document camera 30 and the function keys of the operating panel 44 of the presentation station module 40 are activated to execute different functions. Alternatively, it is designed that the document camera 30 is not electrically connected to the presentation station module 40 after the connecting interface 42 is coupled with the expansion interface 35. For example, the user may operate the operating panel 34 of the document camera 30 to execute the image-capturing and outputting functions and operate the operating panel 44 of the presentation station module 40 to execute the expanded functions such as provision of light compensation.

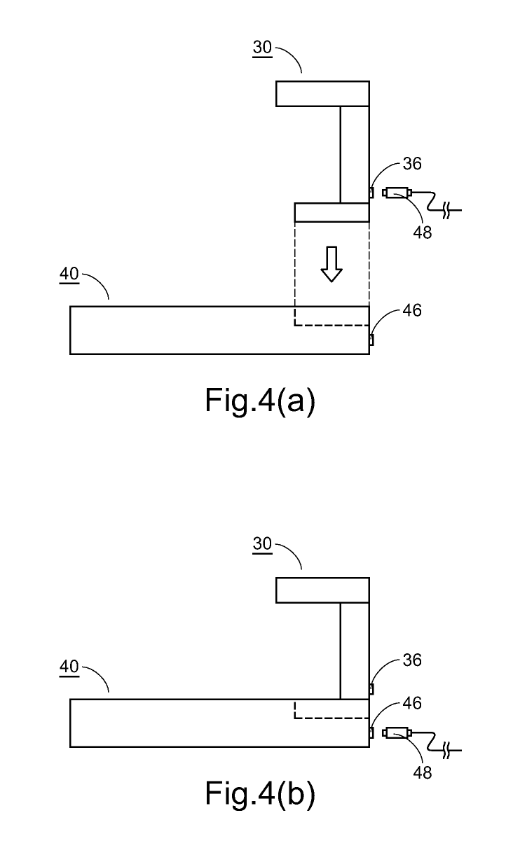

Please refer to FIGS. 4(a) and 4(b), illustrating the document camera 30 and the presentation station module 40 before and after they are assembled, respectively. As shown in FIGS. 4(a) and 4(b), the document camera 30 further includes an image output interface 36 complying with specific specification, e.g. D-Sub, DVI, Composite or S-Video. In a case that the document camera 30 is separated from the presentation station module 40 to be served as the portable document camera, the image output interface 36 of the document camera 30 may be connected to an image output terminal 48 of a projector so that the captured images are transmitted to the projector. Moreover, the presentation station module 40 further includes an image output interface 46 complying with the same specification as the image output interface 36. In a case that the document camera 30 is assembled with and electrically connected to the presentation station module 40, the image output interface 46 of the presentation station module 40 may also be connected to the image output terminal 48 of the projector so that the captured images are transmitted to the projector.

From the above description, the document camera system of the present invention has both the advantages of the portable document camera and the flatbed document camera by selecting desired modules as required. In addition, the document camera system of the present invention is flexible and cost-effective.

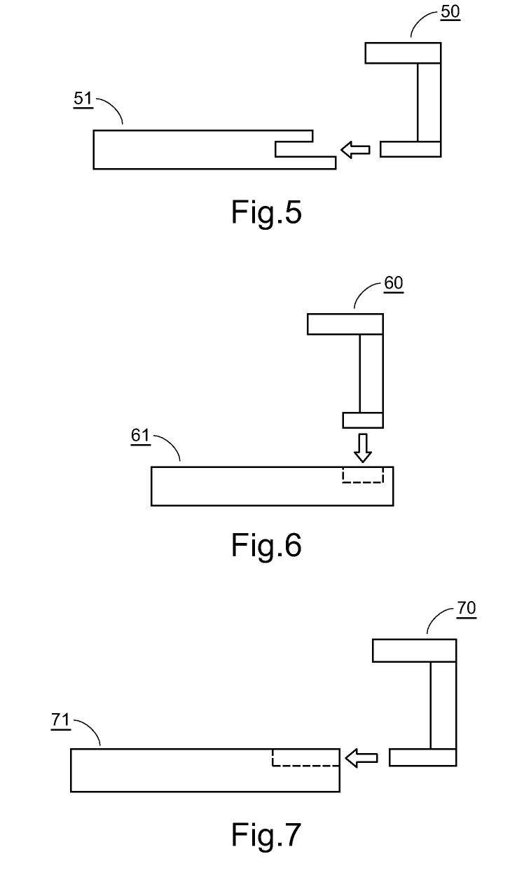

It is noted that, however, those skilled in the art will readily observe that numerous modifications and alterations of the connection between the document camera 30 and the presentation station module 40 may be made while retaining the teachings of the invention. For example, in a second embodiment of FIG. 5, the base of the document camera 50 is horizontally embedded into a slot of the presentation station module 51. In a third embodiment of FIG. 6, the base of the document camera 60 is vertically embedded into a slot of the presentation station module 61. In a fourth embodiment of FIG. 7, the document camera 70 and the presentation station module 71 are coupled in a horizontal manner.

From the above description, the document camera system of the present invention has both the advantages of the portable document camera and the flatbed document camera when the document camera portion is selectively assembled with or detached from the presentation station module. In addition, since the related modules (e.g. the camera module) may be replaced with new ones or the presentation station module is selectively purchased, the document camera system is cost-effective and marketable.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A document camera for capturing and outputting images of an object to be displayed, the document camera being detachably coupled with a presentation station module and comprising:
a main body;
a camera module disposed on said main body for capturing the images of the object;
a first operating panel disposed on said main body and operated by a user to control an image-capturing operation of said camera module and an image outputting operation; and
an expansion interface disposed on said main body, wherein the functions of said document camera are expanded when said document camera is coupled with the presentation station module via said expansion interface.

2. The document camera according to claim 1 wherein said main body further includes a camera stand detachably coupled with said camera module, wherein said camera module is electrically connected to said camera stand when said camera module is coupled with said camera stand.

3. The document camera according to claim 1 wherein said first operating panel comprises a plurality of function keys.

4. The document camera according to claim 1 wherein said presentation station module includes a second operating panel, which includes a plurality of function keys.

5. The document camera according to claim 4 wherein said camera module is electrically connected to the presentation station module when said camera module is coupled with the presentation station module, so that the second operating panel is operated by the user to control the image-capturing operation of said camera module and the image outputting operation.

6. The document camera according to claim 1 wherein the presentation station module is a multi-functional presentation station module for expanding the functions of said document camera.

7. The document camera according to claim 1 wherein the functions of the document camera expanded by the presentation station module comprises provision of light compensation by a light box of the presentation station module.

8. A document camera system for capturing and outputting images of an object to be displayed, comprising:
a document camera comprising a camera module for capturing the images of the object;
a presentation station module selectively coupled with or detached from said document camera, wherein the functions of said document camera are expanded when said document camera is coupled with and electrically connected to said presentation station module, and a first operating panel of said document camera is operated by a user to control an image-capturing operation of said document camera and an image outputting operation when said document camera module is detached from said presentation station module.

9. The document camera system according to claim 8 wherein said document camera further includes a camera stand detachably coupled with said camera module, wherein said camera module is electrically connected to said camera stand when said camera module is coupled with said camera stand.

10. The document camera system according to claim 8 wherein said first operating panel comprises a plurality of function keys.

11. The document camera system according to claim 8 wherein a second operating panel of said presentation station module is operated by the user to control the image-capturing operation of said camera module and the image outputting operation when said document camera is coupled with and electrically connected to said presentation station module.

12. The document camera system according to claim 11 wherein said second operating panel comprises a plurality of function keys.

13. The document camera system according to claim 8 wherein said presentation station module further comprises a platform for placing the object thereon.

14. The document camera system according to claim 8 wherein said presentation station module further comprises a light box for providing light compensation when the images of the object are captured by said camera module.

15. A document camera for capturing and outputting images of an object to be displayed, the document camera being detachably coupled with a presentation station module and comprising:
a base;
a camera stand disposed on said base;
a camera module disposed on said camera stand for capturing the images of the object;
a first operating panel arranged on said base and operated by a user to control an image-capturing operation of said camera module and an image outputting operation; and
an expansion interface disposed on said main body, wherein the functions of said document camera are expanded when said base of said document camera is coupled with the presentation station module via said expansion interface.

16. The document camera according to claim 15 wherein the presentation station module is a multi-functional presentation station module for expanding the functions of said document camera.

17. The document camera according to claim 15 wherein the presentation station module comprises a second operating panel operated by a user to control related operations.
